(19) United States
(12) Patent Application Publication
(10) Pub. No.: US 2009/0216557 A1
(43) Pub. Date: Aug. 27, 2009

(54) Software System for Providing Access Via Pop-Up Windows to Medical Test Results and Information Relating Thereto

(76) Inventors: Kyle Lawton, Manchester, NH (US); Erik Heath, Seymour, CT (US)

Correspondence Address: Russ Weinzimmer, 614 Nashua Street, Suite 53, Milford, NH, 03055, US

(21) Appl. No.: 12/036,291

(22) Filed: Feb. 24, 2008

(51) Int. Cl. G06F 19/00

(52) U.S. Cl. 705/3

(57) ABSTRACT

A software system is disclosed having pop-up windows that efficiently deliver informational and/or actionable messages that provide access to medical test results and related information. The otherwise invisible software receives and displays the messages on a computer where a medical professional can immediately access test results and related information. A pop-up window can include controls that delete messages and/or close the window, and can also include codes used to access medical test results, and/or hyperlinks that automatically open separate windows to display medical test results, context information, and/or other related information. Message elements can be arranged in columns and can be sorted by selecting column headers. In preferred embodiments, the medical professional provides identifying information so that only messages directed to the medical professional are displayed, and in some embodiments displayed messages and responding actions are logged.

### FIELD OF THE INVENTION

The invention generally relates to medical information management, and more specifically to communication of medical information.

### BACKGROUND OF THE INVENTION

Medical testing is essential to monitoring a patient's health and diagnosing medical conditions. Such testing often begins with basic steps, such as asking the patient questions, observing the patient, and palpating the patient. However, in many cases it is necessary to apply one or more highly sophisticated diagnostic testing methods so as to gain a clearer understanding of the patient's condition. Examples of such highly sophisticated diagnostic testing methods include, but are not limited to, digital X-RAY, ultrasound, CT, PET, EKG, EEG, MRI, and f-MRI. Often, more than one of these methods is applied, and the results are compared so as to form a diagnosis that is as accurate as possible.

Applying sophisticated medical testing methods, interpreting the results, and acting upon them typically requires the efforts of a plurality of highly trained and specialized medical professionals. For example, a specially trained technician may operate an MRI so as to obtain an MRI “study” consisting of a series of medical images, a radiologist may “read” the study and provide an interpretation, a diagnostic specialist may form a diagnosis based on the interpretation of the MRI study and other available information, and a surgical team may perform an operation on the patient so as to correct problems identified in the diagnosis.

Demands are constantly placed upon such highly trained and specialized medical professionals to quickly and efficiently receive and act upon messages that relate to medical testing. For example, a diagnostician may receive a message regarding a diagnosis that requires an urgent second opinion. A cardiologist may receive a message regarding the results of an EKG. A staff radiologist may receive a message requiring his or her review of a study interpreted the previous night by a remotely located “night hawk” radiology group. Another radiologist may receive a message requiring him or her to perform a peer review of a previously interpreted study, so as to meet quality improvement requirements imposed by accrediting organizations such as the American College of Radiologists (ACR). Or a resident in training may receive a message from a senior physician instructing him or her to review certain exemplary cases as part of a training program.

Significant advances have been made in providing better and more standardized access to medical test results. These include the adoption of the DICOM standard for reporting, sharing, and viewing medical images and the use of Picture Archiving and Communication System (PACS), or PACS systems, for storing, archiving, and providing access to medical images. However, very little has been done to provide an optimized means for receiving and acting upon messages that relate to medical test results. Delivery of such messages is typically carried out using general communication methods such as telephone calls, emails, text messages, instant messages, fax messages, in-person meetings, and such like. This can lead to inefficiencies regarding when and where a message is received, as well as inefficiencies in acting upon information once it is received.

For example, a time critical email may only be received the next time an medical professional checks his or her email. A text message may be received on a cell phone at a time when a medical professional is not at a hospital or clinic, or is otherwise not able to gain access to referenced test results. Worse yet, the message may be forgotten by the time the medical professional is next in a position to review the referenced test results and take action. A telephone message or fax message may be received by a medical professional, and then it may be necessary for the medical professional to manually input an accession number or other identifying information into a PACS system, or to carry out excessive browsing through a PACS system, so as to eventually gain access to test results referenced by the message. Or an email notification may be received by a medical professional regarding a change in policy, for example a change as to the reporting of critical test findings, and the medical professional may need to spend time inputting a link or browsing through menus so as to review the change in more detail and/or review the general policies of the organization so as to place the change in better context.

### SUMMARY OF THE INVENTION

A computer software system is claimed for providing access to medical test results and information relating to medical test results. The computer software system includes “pop-up” windows for efficiently delivering to a medical professional informational and/or actionable messages where and when they are most effective and most needed, by placing them on the screen of a computer that can be immediately used by the medical professional to access medical test results and/or context or other information related to medical test results. The messages appear on top of any overlapping graphical elements, so that they draw the immediate attention of the medical professional using the computer.

In one general aspect of the invention, the computer software system carries out a method that includes receiving a message related to a medical test result and/or information pertaining to at least one medical test result and presenting the received message in a pop-up window on a display of the computer, the pop-up window being arranged on top of all other coextensive graphical elements, so as to be visible to the medical professional.

In preferred embodiments, the pop-up window includes at least one control that can be activated by the medical professional, and in some of these preferred embodiments the control causes the pop-up window to close until another message is received by the computer software system, and/or a control to temporarily close for a specified amount of time. Embodiments also include controls to set the specified amount of time for temporarily closing, delete a message from the pop-up window, and/or delete all messages from the pop-up window.

In preferred embodiments, the pop-up window presents an identifying code or other access information that can be entered into information viewing software on the computer so as to view and/or otherwise manipulate medical test results, context information, or other information pertaining to a message presented in the pop-up window. In some of these preferred embodiments, the access information can be transferred from the pop-up window to the information viewing software by either cutting or copying it from the pop-up window and then pasting it into the viewing software.

In other preferred embodiments messages presented in the pop-up window include a hyperlink that can be activated so as to automatically gain access to information pertinent to the message, such as medical test results and/or context information.

In preferred embodiments, the operation of the computer software system is substantially invisible to the medical professional when no messages are being displayed in a pop-up window. In some preferred embodiments information elements included in messages are presented in the pop-up window in columns, and the messages are automatically sorted according to the information in a column when the medical professional clicks on a column header.

In certain preferred embodiments, the computer software system records information regarding messages displayed in pop-up windows and actions taken by the medical professional in response to such messages. In other preferred embodiments the medical professional provides identifying information to the computer, while logging in or separately from logging in, and the computer software system only presents messages that are directed to the medical professional.

In another general aspect of the invention, the computer software system carries out a method that includes receiving at least one message related to a medical test result and/or information pertaining to a medical test result, presenting a pop-up window on a display of the computer, the pop-up window being arranged on top of all other coextensive graphical elements, so as to be visible to the medical professional, and presenting a message in the pop-up window, the messages including a hyperlink that can be activated by the medical professional so as to at least view information pertaining to the message, such as a medical test result or context information.

In preferred embodiments of this general aspect of the invention, the pop-up window includes a control that can be activated by the medical professional, and in some of these embodiments activating the control causes the pop-up window to close until another message is received by the computer software system, causes the pop-up window to temporarily close for a specified amount of time, allows the medical professional to set the specified amount of time for temporarily closing, deletes a message from the pop-up window, or deletes all messages from the pop-up window.

In some preferred embodiments of this general aspect of the invention each message displayed in the pop-up window includes a hyperlink that can be activated by the medical professional so as to at least view medical test results that pertain to the message, and each message displayed in the pop-up windows also includes a hyperlink that can be activated by the medical professional so as to at least view information that relates to the context of the message.

In yet another general aspect of the invention a method is claimed for providing to a medical professional access to medical test results and information pertaining thereto. The method includes delivering to the computer a message related to a medical test result and/or information pertaining to at least one medical test result, and presenting the message in a pop-up window on a display of the computer, the pop-up window being arranged on top of all other coextensive graphical elements, so as to be visible to the medical professional. In preferred embodiments of this aspect of the invention, a message presented in the pop-up window includes a hyperlink that can be activated so as to automatically access a medical test result relating to the message, context relating to the message, and/or other information relating to the message.

### BRIEF DESCRIPTION OF THE DRAWINGS

FIG. 1 is a conceptual diagram that illustrates the interactions between medical testing modalities and collaborating medical professionals in a typical hospital radiology department;

FIG. 2A illustrates display of messages in a pop-up window of a preferred embodiment;

FIG. 2B illustrates the activation of hyperlinks in the pop-up window of FIG. 2A so as to display a radiographic study and a list of related medical test results;

FIG. 3 is a functional diagram illustrating use of the present invention by a radiologist performing peer reviews of radiographs;

FIG. 4 is a window used by a radiologist in a preferred embodiment to report the results of a peer review and to request notification by email and pop-up message of any future updates to the case;

FIG. 5 is a functional diagram illustrating use of the present invention by a hospital emergency department to request that a staff radiologist review an interpretation of an MRI study provided by a nighthawk service;

FIG. 6 is a functional diagram illustrating use of the present invention to notify a staff radiologist regarding a change in the list of critical test results that must be reported to the JCAHO accreditation service;

FIG. 7 is a functional diagram illustrating use of the present invention by a radiologist to send a message to a group of radiology residents instructing them to review a specific study in preparation for a future discussion; and

FIG. 8 illustrates display of messages in a pop-up window of a preferred embodiment wherein a general title and message are provide together with a list of specific medical test results.

### DETAILED DESCRIPTION OF PREFERRED EMBODIMENTS

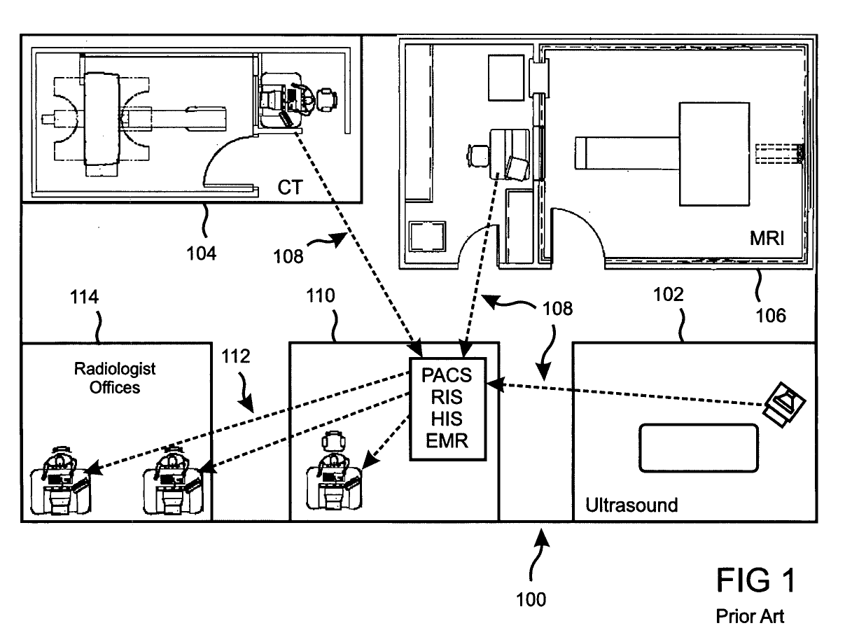

With reference to FIG. 1, a radiology department 100 in a typical hospital or clinic includes a plurality of diagnostic imaging modalities, such as ultrasound 102, CT 104, and MRI 106. So as to efficiently store, archive, and provide access to results from most or all of these modalities, medical test results from the imaging modalities are transferred 108 automatically to a server 110 that provides medical information management functionalities, such as a Picture Archiving System, or PACS, a Radiological Information System, or RIS, a Hospital information System, or HIS, and/or an Electronic Medical Record system, or EMR. The server 110 can in turn can be accessed 112 by radiologists 114 who wish to view medical information, medical interpretations, and medical test results stored on the server 110.

Efficient testing, diagnosis, and treatment of a patient typically requires a close collaboration between technicians operating the ultrasound 102, CT 104, MRI 106 and other medical test equipment, radiologists 114 and other specialists who read and interpret medical test results, diagnosticians who use medical test results together with information supplied by the patient and other factors to diagnose medical conditions, and surgeons and other treatment specialists who treat conditions identified in the diagnosis. This close collaboration requires efficient communication between all of the collaborating medical professionals, and much of this communication relates directly or indirectly to medical test results and prompts collaborating medical professionals to view and interpret medical test results referenced in communicated messages.

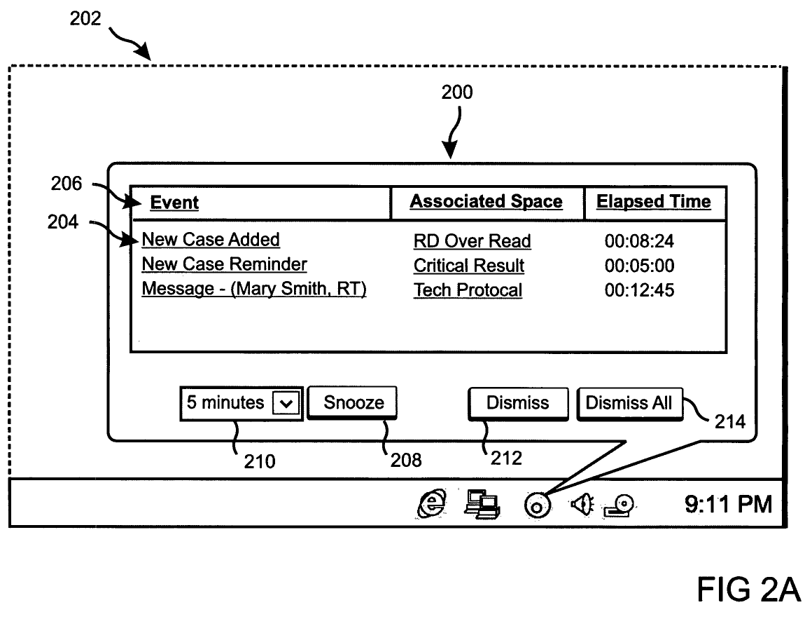

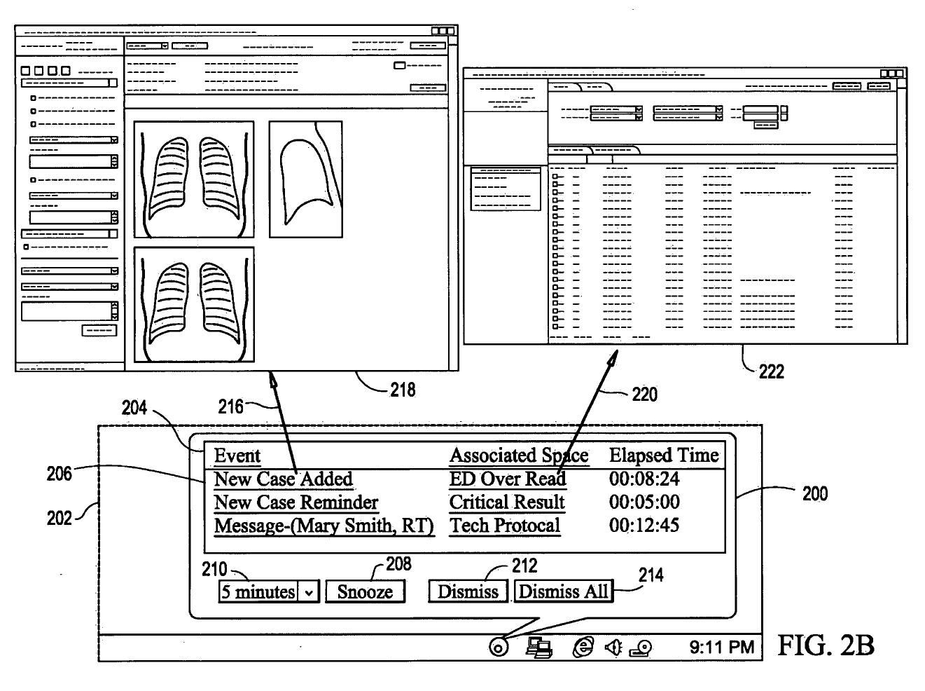

With reference to FIG. 2, in the present invention the delivery to a medical professional of a message that relates to medical test results is facilitated and made more efficient by displaying a pop-up window 200 on the screen 202 of a computer being used by the medical professional. The pop-up window 200 is displayed on top of any overlapping graphical elements, so that it is brought to the immediate attention of the medical professional using the computer. In the preferred embodiment of FIG. 2, the pop-up window 202 can contain message elements 204 from a plurality of messages, with the message elements 204 arranged in columns below column headers 206 and each row 204 corresponding to a separate message.

In the preferred embodiment of FIG. 2A, message elements 204 in two of the columns are hyperlinks that can be activated to view additional information relating to a message. Activating a hyperlink in the first column causes display in a separate window of information directly referred to in the message, such as a specific radiographic imaging study. Activating a hyperlink in the second column causes display in a separate window of information that provides context related to the message, such as a list of other radiographic studies performed on the same patient or a list of other radiographic studies that have also been assigned to the same medical professional for interpretation or review. Entries in a third column indicate the time that has elapsed since each message was first delivered.

In the preferred embodiment of FIG. 2A, the pop-up window 200 also includes several additional controls 208, 210, 212, 214 that can be used to control the behavior of the pop-up window and the message information contained therein. A “snooze” button 208 can be activated to cause the pop-up window 200 to disappear for a specified amount of time, a drop-down list 210 can be used to select how much time will elapse after the snooze button 208 is activated before the pop-up window 200 reappears, a “dismiss” button 212 can be activated to remove a selected message row 204 from the message list, and a “dismiss all” button can be activated to remove all message rows 204 from the message list and close the pop-up window 200 until such time as a new message is received.

FIG. 2B illustrates the effect of activating hyperlinks in the first or second column of message elements 204 in the pop-up window 200 of FIG. 2A. Activating the hyperlink in the first row and first column 216 results in a new window 218 being opened that contains the results of a digital X-ray study that has just been assigned to the message recipient for peer review. Activating the hyperlink in the second column of the same row 220 results in a new window 222 being opened that contains a list of other medical test results that have been assigned to the message recipient for peer review.

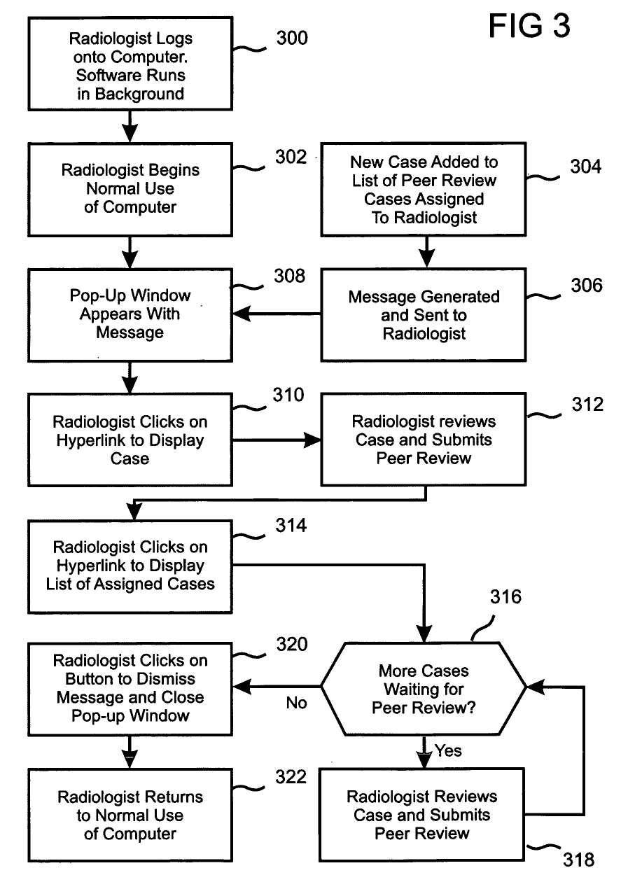

FIG. 3 is a functional diagram that illustrates use of a preferred embodiment of the present invention to alert a radiologist that a certain radiographic study as been assigned to the radiologist for peer review. The process begins with the radiologist logging onto a workstation computer 300 that is able to communicate with a server computer that maintains lists of peer review cases assigned to radiologists for review. In this preferred embodiment, logging onto the workstation computer 300 automatically causes the computer software system of the present invention to be activated on the computer, although it is nearly invisible to the radiologist. The process of logging onto the workstation computer 300 also informs the system of the identity of the radiologist and the identity of the workstation that he or she is using. Because no messages have yet been delivered, the radiologist begins normal use of the computer 302.

When a new case is added to the peer review list assigned to the radiologist 304, a message is automatically generated 306 and transmitted to the message receiving computer software system, and the message receiving computer software system causes a pop-up window appears 308 on the workstation computer being used by the radiologist. Since the pop-up window appears automatically and is displayed on top of any overlapping graphical elements, the radiologist is immediately aware that a new message has been delivered. Because the message appears on a workstation computer used by the radiologist, it is delivered to the radiologist when and where the radiologist is most able to respond to the message. The radiologist responds to the message by clicking on a hyperlink contained in the pop-up window 310, thereby causing the newly assigned case to appear in a separate window that allows the images in the study to be browsed, enlarged, and otherwise viewed and manipulated for interpretation. Note that because of the hyperlink provided in the pop-up window, the radiologist is able to begin reviewing the assigned study after only a single mouse click.

Upon completing and submitting 312 his or her review of the assigned study, the radiologist finds that it is a good time to complete all of the studies currently assigned to him or her for review. The radiologist therefore activates another hyperlink 314 provided in the pop-up window, and thereby causes a new window to open that displays a complete list of his or her assigned peer review cases. If more cases are waiting for review 316, the radiologist then proceeds to open and review each them 318 until peer review reports have been submitted for all of them. The radiologist then clicks on a button in the pop-up window 320 that dismisses the message and closes the pop-up window. The radiologist can then continue with his or her normal use of the computer 322 until another message arrives.

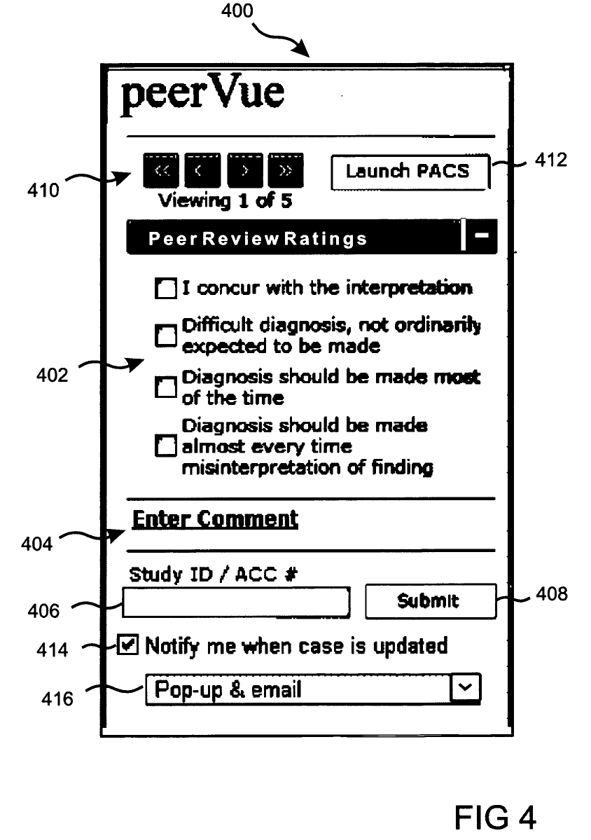

A typical window 400 used by a radiologist to submit a peer review report is illustrated in FIG. 4. The window contains checkboxes 402 used to provide standard review ratings as well as a field for comments 404. Studies can be accessed by entering a study ID or accession number into a study locating field 406 and clicking on a “submit” button 408. As alternatives, a series of studies can be accessed using a set of scroll buttons 410, or the PACS software can be launched 412 so as to browse and locate a study of interest. When a study is accessed by clicking on a hyperlink 314 in a pop-up window or in a list of assigned peer review cases, the study locating field 406 is automatically filled in and the study is automatically accessed.

In the preferred embodiment of FIG. 4, when a peer review report is submitted, the radiologist can indicate by selecting a check box 414 that he or she wishes to be informed of any future updates to the case, and a drop-down box 416 is used to indicate the desired means for being informed. In FIG. 4, the radiologist has indicated a desire to be informed by both email and pop-up message.

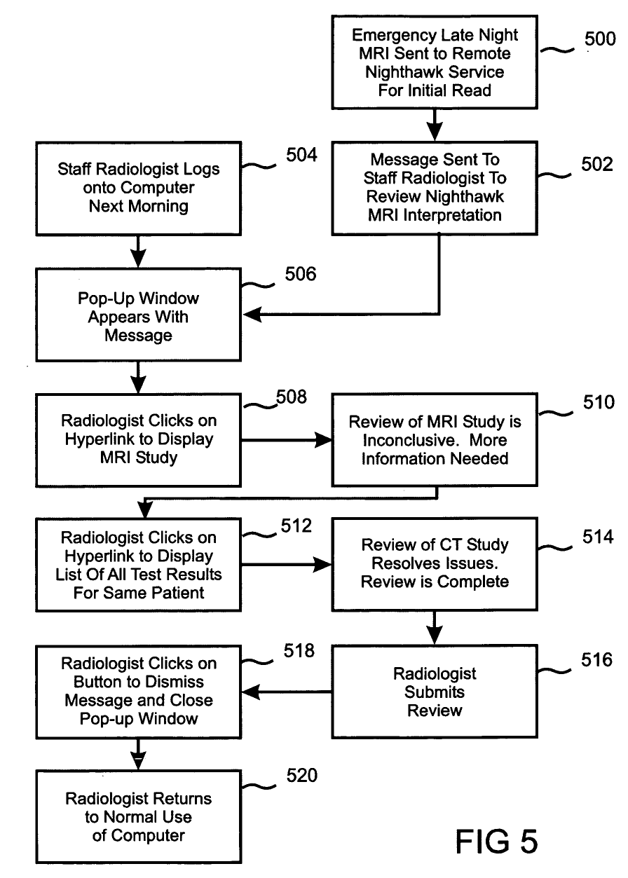

FIG. 5 is a functional diagram that illustrates use of a preferred embodiment of the present invention to notify a radiologist of a need to review an emergency MRI interpretation provided by a nighthawk service at the request of emergency late night medical personnel. After submitting the MRI study to the nighthawk service for review 500, the emergency personnel cause a message 502 to be sent to a staff radiologist. When the staff radiologist logs into his or her computer the following morning 504, a pop-up window containing the message immediately appears 506 on the radiologist's workstation computer. The radiologist clicks on a hyperlink in the message 508, causing the MRI study to appear in a separate window together with the interpretation provided by the nighthawk service.

The radiologist then begins his or her interpretation of the MRI study 510, but finds that there are some possible lesions that cannot be fully identified by the MRI results alone. The radiologist then clicks 512 on another hyperlink provided in the pop-up window, causing a window to appear containing a list of other medical tests that were performed on the same patient. From this list, the radiologist selects a CT study, and by comparing the CT study to the MRI study the radiologist is able to fully identify the lesions and complete the review 514. The radiologist then submits the review 516, clicks on a button in the pop-up window to dismiss the message and close the pop-up window 518, and returns to his or her normal use of the computer 520.

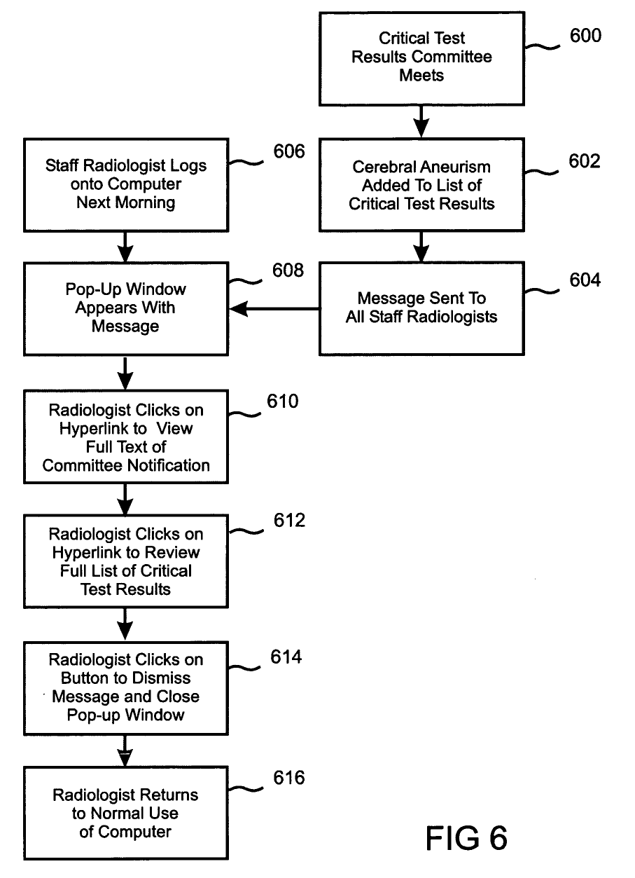

FIG. 6 is a functional diagram that illustrates use of a preferred embodiment of the present invention to notify staff radiologists at a hospital or clinic of a change in the list of critical test results that must be reported to the JCAHO or to a similar monitoring and accrediting organization. When the critical test results committee at the hospital or clinic meets 600 during the evening and adds a new critical test result (cerebral aneurism) to the critical test results list 602, an informing message is sent 604 to all staff radiologists. When a radiologist logs onto his or her workstation the next morning 606, a pop-up window containing the message appears 608.

In some preferred embodiments, the pop-up window and message contain no hyperlinks, but are simply viewed and then closed. However, in the preferred embodiment of FIG. 6, hyperlinks are included in the message. The radiologist clicks on one of the hyperlinks 610, causing the full text of the announcement to open in a separate window, and then clicks on another hyperlink 612 in the message, causing a separate window to open containing the complete list of all critical test results that require reporting to outside organizations. Finally, the radiologist clicks on a button that dismisses the message and closes the pop-up window 614, and the radiologist returns 616 to normal use of the workstation computer. In some preferred embodiments, the delivery of pop-up messages and the responding actions taken by the recipient are logged by software either on the message receiving computer or on another computer in communication with the message receiving computer. For example, in the scenario described with reference to FIG. 6, such logging can be used to verify that the message announcing the addition of a new critical test result has been received by the radiologist, and that the radiologist has taken the time to view the full text of the announcement.

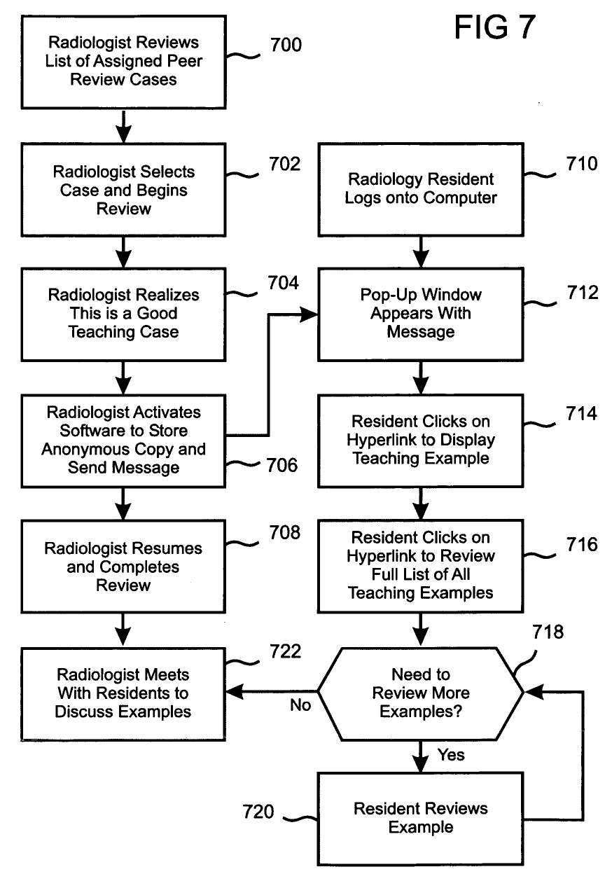

FIG. 7 is a functional diagram that illustrates use of a preferred embodiment of the present invention to notify radiology residents of a radiographic study identified by a radiologist and provided to the residents as an example to be used in their training. The radiologist begins by reviewing an assigned list of peer review cases 700, and selects one to be reviewed 702. During the review, the radiologist realizes 704 that this study includes unusual features, and that it would be a good teaching example to present to a group of radiology residents that he is training. The radiologist therefore activates software that stores a copy of the study with all identifying information removed (so as to satisfy HIPPA requirements) and sends a message 706 to the group of radiology residents. The radiologist then continues and completes his or her review of the study 708 and the remainder of the peer review cases.

Meanwhile, a radiology resident logs onto his or her workstation computer 710, whereupon a pop-up window containing the message appears 712. The resident clicks on a hyperlink 714 provided in the message, causing the anonymous copy of the example study to appear in a separate window. After reviewing that study, the resident realizes that he or she is behind in preparing for the next training meeting with the radiologist. The resident therefore clicks on another hyperlink 716 also provided in the message, causing a full list to appear in a separate window of all of the teaching examples that will be discussed at the next training meeting. The resident considers each example on the list, and if the resident needs to review an example 718 in preparation for the training meeting, the resident clicks on a hyperlink included in the list and reviews the example 720. As a result, the resident is fully prepared when the training meeting takes place 722, and receives optimum benefit from the meeting.

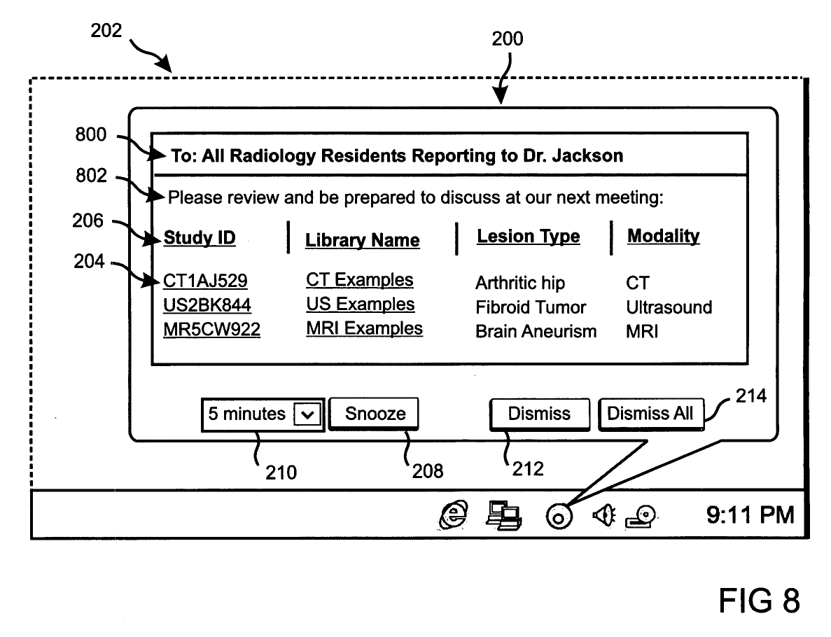

FIG. 8 presents an example in a preferred embodiment of a pop-window 200 and messages 204 as could be used in a scenario similar to the one described with reference to FIG. 7. The pop-up window 200 includes a message header 800 and overall message 802, as well as individual message elements arranged in rows and columns 204, with each row representing a specific radiographic study and each column representing a type of message element. The rows 204 can be sorted alphabetically according to the elements in a column by clicking on the corresponding column header 206.

Embodiments similar to those presented above apply to preferred embodiments of the present invention used for delivery of messages to surgeons, diagnosticians, and other medical professionals that collaborate to acquire, interpret, and use medical test results. For example, a pop-up of the present invention can be used to inform a technician that he or she has been scheduled to operate equipment during acquisition of a new study, or to notify a surgeon that a lesion has been identified and that surgery may be required.

Other modifications and implementations will occur to those skilled in the art without departing from the spirit and the scope of the invention as claimed. Accordingly, the above description is not intended to limit the invention except as indicated in the following claims.

What is claimed is:

1. A computer software system having a set of instructions for controlling a general purpose computer so as to provide to a medical professional using the computer access to medical test results and information pertaining thereto, the software system carrying out a method comprising:
receiving a message related to at least one of a medical test result and information pertaining to at least one medical test result; and
presenting the received message in a pop-up window on a display of the computer, the pop-up window being visible to the medical professional.

2. The computer software system of claim 1, wherein the pop-up window is opaque and is presented on top of any coextensive content.

3. The computer software system of claim 1, wherein the pop-up window includes at least one control element that can be activated by the medical professional.

4. The computer software system of claim 3, wherein the control element is at least one of:
a control element that causes the pop-up window to close until another message is delivered to the computer software system;
a control element that causes the pop-up window to close for a specified amount of time;
a control element that allows the medical professional to set the specified amount of time that the window remains closed;
a control element that deletes a message from the pop-up window; and
a control element that deletes all messages from the pop-up window.

5. The computer software system of claim 1, wherein the pop-up window presents accessing information that can be entered into information viewing software so as to at least view information related to a message presented in the pop-up window.

6. The computer software system of claim 5, wherein the information is at least one of a medical test result, information relating to context of the message, and other information related to the message.

7. The computer software system of claim 5, wherein the accessing information can be transferred from the pop-up window to the information viewing software by one of a cut-and paste action and a copy-and-paste action.

8. The computer software system of claim 1, wherein a message presented in the pop-up window includes a hyperlink that can be activated so as to automatically access at least one of a medical test result related to the message, context related to the message, and other information related to the message.

9. The computer software system of claim 1, wherein operation of the computer software system on the computer is substantially invisible to the medical professional when the software is not presenting a message in a pop-up window.

10. The computer software system of claim 1, wherein the pop-up window presents a plurality of messages with information elements arranged in at least one column, and wherein the medical professional can activate a column header so as to sort the messages according to the information elements presented in a corresponding column.

11. The computer software system of claim 1, the method further comprising:
logging information regarding at least one of messages displayed in pop-up windows and actions taken by the medical professional in response to messages displayed in pop-up windows.

12. The computer software system of claim 1, the method further comprising:
determining the identity of the medical professional; and
presenting only messages that are directed to the medical professional.

13. A computer software system having a set of instructions for controlling a general purpose computer so as to provide to a medical professional using the computer access to medical test results and information pertaining thereto, the software system carrying out a method comprising:
receiving a message related to at least one of a medical test result and information pertaining to at least one medical test result;
presenting a pop-up window on a display of the computer, the pop-up window being visible to the medical professional; and
presenting at least one message in the pop-up window, the message including a hyperlink that can be activated by the medical professional so as to at least view information relating to the message.

14. The computer software system of claim 13, wherein the information is at least one of a medical test result, information relating to context of the message, and other information related to the message.

15. The computer software system of claim 13, wherein the pop-up window includes a control element that can be activated by the medical professional, the control element being at least one of:
a control element that causes the pop-up window to close until another message is received by the computer software system;
a control element that causes the pop-up window to close for a specified amount of time;
a control element that allows the medical professional to set the specified amount of time that the window remains closed;
a control element that deletes a message from the pop-up window; and
a control element that deletes all messages from the pop-up window.

16. The computer software system of claim 13, wherein each message displayed in the pop-up window includes a hyperlink that can be activated by the medical professional so as to at least view medical test results that pertain to the message, and each message displayed in the pop-up window also includes a hyperlink that can be activated by the medical professional so as to at least view information that relates to the context of the message.

17. The computer software system of claim 13, the method further comprising:
determining the identity of the medical professional; and
presenting only messages that are directed to the medical professional.

18. A method for providing to a medical professional access to medical test results and information pertaining thereto, the method comprising:
delivering to a computer at least one message related to at least one of a medical test result and information pertaining to at least one medical test result; and
presenting at least one received message in a pop-up window on a display of the computer, the pop-up window being visible to the medical professional.

19. The method of claim 18, wherein the message presented in the pop-up window includes a hyperlink that can be activated so as to automatically access at least one of a medical test result relating to the message, context relating to the message, and other information relating to the message.
